(19) United States
(12) Patent Application Publication
(10) Pub. No.: US 2012/0192748 A1
(43) Pub. Date: Aug. 2, 2012

(54) COUPLING ADAPTER

(76) Inventors: Eric Scheid, Bloomington, IN (US); Brad Moan, Greenwood, IN (US); Scott Germain, Hope Mills, NC (US)

(21) Appl. No.: 13/162,718

(22) Filed: Jun. 17, 2011

Related U.S. Application Data
(60) Provisional application No. 61/438,793, filed on Feb. 2, 2011.

(51) Int. Cl. F16D 1/00; C06C 7/00; B23P 17/04; C06C 5/00

(52) U.S. Cl. 102/275.11; 403/221; 29/428

(57) ABSTRACT

A coupling adapter including a side wall and a plurality of circumferentially spaced retaining fins supported by the side wall and extending radially inwardly in order to provide a variable diameter interference fit with an elongated member.

### CROSS-REFERENCE TO RELATED APPLICATION

This application claims priority to U.S. Provisional Patent Application Ser. No. 61/438,793, filed Feb. 2, 2011, the disclosure of which is expressly incorporated by reference herein.

### STATEMENT REGARDING FEDERALLY SPONSORED RESEARCH OR DEVELOPMENT

The invention described herein includes contributions by one or more employees of the Department of the Navy made in performance of official duties and may be manufactured, used and licensed by or for the United States Government for any governmental purpose without payment of any royalties thereon.

### BACKGROUND AND SUMMARY OF THE DISCLOSURE

The present disclosure relates generally to coupling adapters for securing together different sized components and, more particularly, to a coupling adapter configured to provide for the direct insertion of various detonators and/or blasting caps into explosive charges.

Conventional military and commercial demolition systems typically require a variety of explosive detonators and/or blasting caps to insure their proper operation. These detonators and/or blasting caps are produced in various lengths and diameters and may have different input leads depending upon their particular nature (electric, non-electric, exploding bridgewire detonator, etc.). A typical detonator well consists of a cylindrical, threaded hole protruding into the explosive device. The appropriate detonator and/or cap is then inserted into the detonator well, which typically requires a specialized adapter that accounts for the individual detonator design and serves to secure the detonator to the charge.

As such, a potential exists that for every unique detonator there is a specialized adapter required for its use. This often causes difficulty in field use and logistics support because of the need to recognize and insure the availability of the appropriate adapter as needed. Conventional specialized adapters are typically threaded parts requiring careful installation by the user into the accepting detonator well. This is often a dangerous and time consuming process.

As such, there is a need for a system to reduce and/or eliminate the amount of specialized accessories necessary to adapt different sized detonators to explosive charges. Such reduction or elimination of specialized adapters saves the user time, weight, and space, while also reducing the risk to the system caused by lost and/or omitted parts.

According to an illustrative embodiment of the present disclosure, a coupling adapter includes a side wall having an inner surface, a plurality of circumferentially spaced retaining fins supported by the side wall, wherein each of the retaining fins extends radially inwardly from an outer end coupled to the inner surface of the side wall to an inner end. The coupler adapter further includes a receiving bore defined by the inner ends of the retaining fins, wherein the receiving bores extend axially between a first end and a second end and are configured to receive an elongated member. Each of the retaining fins is flexible for bending movement in tangential and radially outward directions to retain elongated members of varying lateral dimensions slidably received within the receiving bore.

According to another illustrative embodiment of the present disclosure, a coupling adapter includes a side wall and a plurality of circumferentially spaced retaining fins supported by the side wall. Each of the retaining fins extends radially inwardly from an outer end coupled to the inner surface of the side wall to an inner end, wherein each of the retaining fins is flexible such that the inner end is supported to move relative to the outer end. A receiving bore is defined by the retaining fins and is configured to receive an elongated member. The receiving bore includes a first diameter defined by the retaining fins when in a relaxed mode, a second diameter defined by the retaining fins when in a first expanded mode, and a third diameter defined by the retaining fins when in a second expanded mode. The second diameter is greater than the first diameter, and the third diameter is greater than the second diameter.

According to a further illustrative embodiment of the present disclosure, a detonator assembly for an explosive charge includes a housing configured to receive an explosive charge, a holder coupled to the housing, and a coupling adapter coupled to the holder and including a side wall. The coupling adapter includes a plurality of retaining fins extending inwardly from the side wall, and a receiving bore defined by the retaining fins and having a variable cross-section defined by the retaining fins. A detonator is received within the receiving bore, and bends the inner edges of the fins outwardly to adjust the cross-section of the receiving bore and provide an interference fit between the detonator and the retaining fins.

According to another illustrative embodiment of the present disclosure, a method of coupling includes the steps of providing a coupling adapter including a sidewall and a plurality of inwardly extending retaining fins, the retaining fins defining a receiving bore, slidably inserting an elongated member within the receiving bore of the coupling adapter, bending the retaining fins outwardly to increase the cross-section of the retaining bore, and retaining the elongated member through an interference fit with the retaining fins.

### BRIEF DESCRIPTION OF THE DRAWINGS

The foregoing aspects and many of the attendant advantages of this invention will become more readily appreciated as the same become better understood by reference to the following detailed description when taken in conjunction with the accompanying drawings.

FIG. 1 is a perspective view of an explosive charge including the coupling adapter of the present disclosure;

FIG. 2 is an exploded perspective view of the explosive charge of FIG. 1;

FIG. 3 is a cross-sectional view taken along line 3-3 of FIG. 1;

FIG. 4 is a perspective view of the coupling adapter of the present disclosure;

FIG. 5 is a side elevational view of the coupling adapter of FIG. 4;

FIG. 6 is a cross-sectional view taken along line 6-6 of FIG. 5;

FIG. 7 is a first end view of the coupling adapter of FIG. 4;

FIG. 8 is a second end view of the coupling adapter of FIG. 4;

FIG. 9 is a cross-sectional view taken along line 9-9 of FIG. 5, showing an elongated member having a first diameter slidably received within the receiving bore; and

FIG. 10 is a cross-sectional view similar to FIG. 9, showing an elongated member having a second diameter greater than the first diameter slidably received within the receiving bore.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates embodiments of the invention, and such exemplifications are not to be construed as limiting the scope of the invention in any manner.

### DETAILED DESCRIPTION OF THE DRAWINGS

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

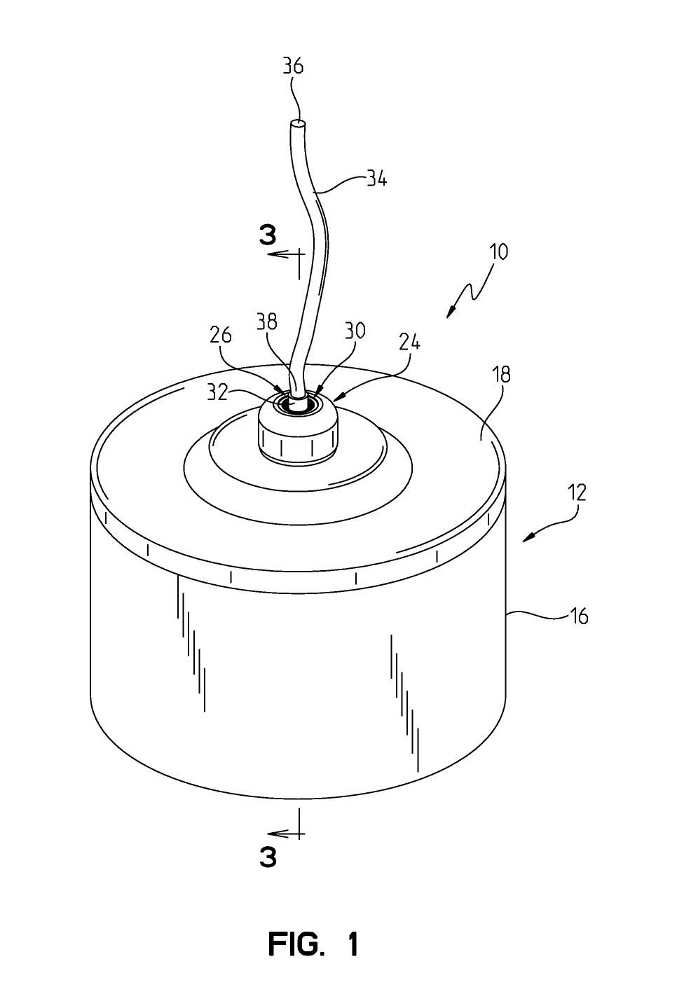

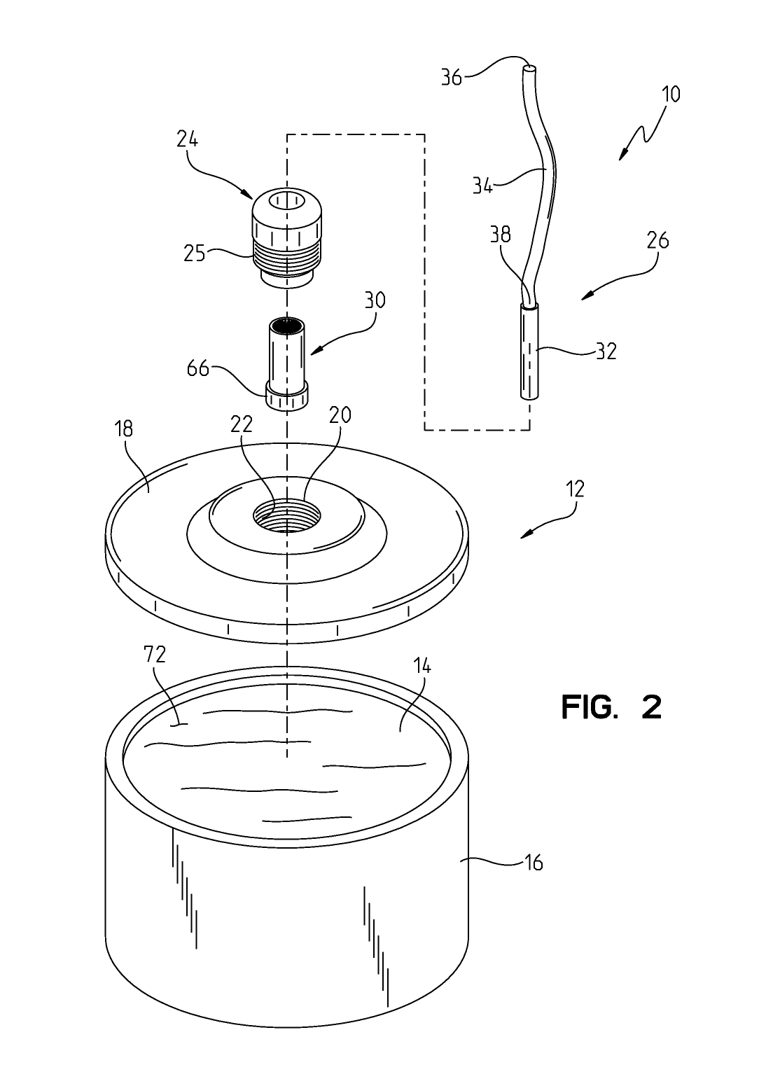

Referring initially to FIGS. 1-3, an illustrated explosive device 10 is shown as including a housing 12 receiving a secondary explosive material 14. While the secondary explosive material 14 may vary, it is generally a relatively stable explosive that is insensitive to heat and shock, and is typically initiated by a primary explosive. Suitable secondary explosive materials for use in explosive device 10 include, for example, cyclotrimethylenetrinitramine (RDX), cyclotetramethylene-tetranitramine (HMX), and trinitrotoluene (TNT).

The housing 12 illustratively includes a cylindrical base member or canister 16 and a cover or lid 18 operably coupled thereto. The cover 18 may be secured to the canister 16 though conventional means, such as fasteners, adhesives, or cooperating threads. The cover 18 includes a central bore 20 having internal threads 22. A holder 24 including external threads 25 is configured to be received within the bore 20 and threadably couple with internal threads 22 of the cover 18. A coupling adapter or receptacle 30 is operably coupled to the cover 18 by the holder 24 and is configured to slidably receive a detonator 26, sometimes referred to as a “blasting cap.”

Detonator 26 includes a casing 32 containing a relatively sensitive, primary explosive material (not shown), which is less stable, and therefore easier to ignite, than the secondary explosive material 14 contained in canister 16. Because detonator 26 may easily ignite, detonators 26 are typically stored apart from explosive device 10.

The types of detonators 26 used with explosive device 10 may vary. Suitable detonators 26 may include, for example, non-electric caps, electric caps which are triggered by an electric current, and fuse caps which are triggered with a heat source. Detonators 26 may include instantaneous electric blasting caps, instantaneous non-electric blasting caps, HERO safe electric blasting caps, exploding bridge wire (EBW), detonators, and non-electric delay blasting caps and detonators. For example, illustrative detonators 26 may include M7 non-electric detonators, M6 electric blasting caps, and MK17 electric blasting caps having outer diameters of approximately 0.24 inches and available from a variety of sources. Illustrative detonators 26 may also include RP-83 EBW detonators having outer diameters of approximately 0.272 inches and available from RISI of Tracy, Calif., and non-electric delay detonators having outer diameters of approximately 0.295 inches and available from various sources.

The primary explosive material contained in the casing 32 of detonator 26 may also vary. Suitable primary explosive materials for use in detonator 26 includes, for example, pentaerythritol tetranitrate (PETN), cyclotrimethylenetrinitramine (RDX), mercury fulminate, lead azide, lead styphnate, tetryl, and diazodinitrophenol (DDNP).

The illustrative detonator 26 may be operably coupled to a transmission line, illustratively a non-electric transmission line 34. Transmission line 34 may be provided in the form of a “detonating cord” or “detcord.” Transmission line 34 may also be provided in the form of a “shock tube.” In the detcord embodiment, transmission line 34 may include a flexible, hollow tube that contains a secondary explosive material (not shown). The secondary explosive material in the transmission line 34 may convey or transmit an explosive charge from an input end 36 to an output end 38 coupled to the detonator 26, allowing transmission lines 34 to act as high-speed fuses.

The type and quantity of the secondary explosive material contained in transmission line 34 may vary. In the case of a detcord, a suitable secondary explosive material for use in transmission line 34 includes, for example, pentaerythritol tetranitrate (PETN). In the case of a shocktube, a suitable secondary explosive material for use in transmission lines 34 includes, for example, a mixture of cyclotetramethylene-tetranitramine (HMX) and aluminum. Also, transmission line 34 may contain 5 grains of explosive per foot, for example, although it is also within the scope of the present disclosure that transmission line 34 may contain 0.1 grains of explosive per foot, 2.5 grains of explosive per foot, 7.5 grains of explosive per foot, or 10 grains of explosive per foot, or 50 grains of explosive per foot, for example.

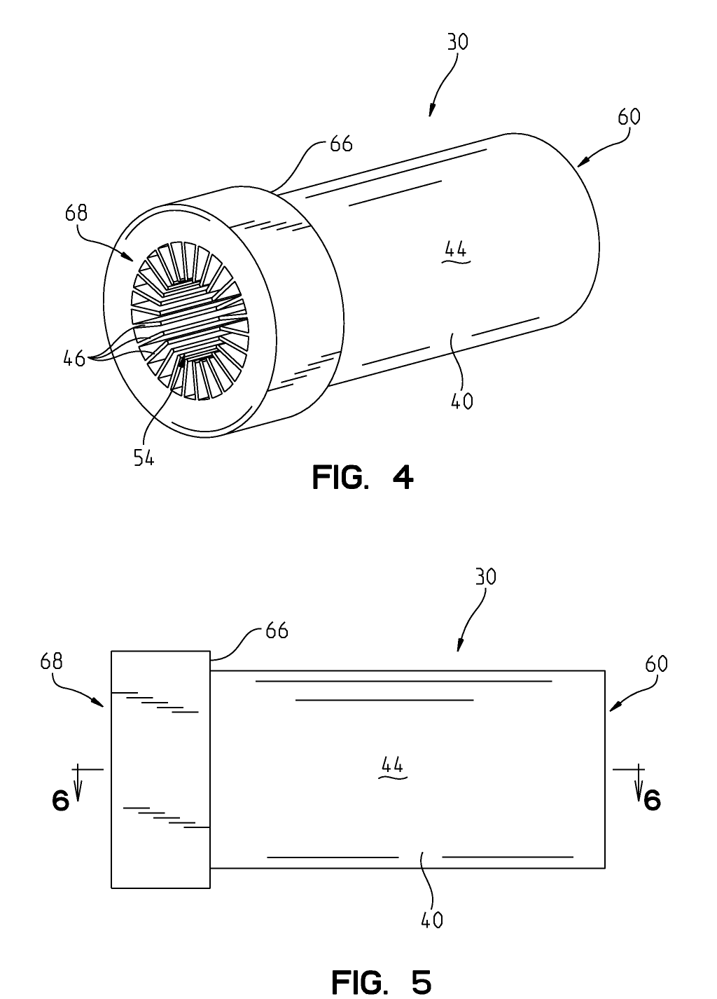

With reference now to FIGS. 4-8, the coupling adapter 30 includes a cylindrical side wall 40 extending axially and including an inner surface 42 and outer surface 44. A plurality of circumferentially spaced retaining fins 46 are supported by the side wall 40. More particularly, each of the retaining fins 46 extends radially inwardly from an outer end 48 coupled to inner surface 42 of the side wall 40 to a freely supported inner end 50. The retaining fins 46 define a central receiving bore 54 configured to receive and releasably couple with an elongated coupled member, illustratively detonator 26. In the illustrative embodiment, twenty-six retaining fins 46 are provided. However, the number of retaining fins 46 may vary depending upon the outer dimensions of the coupled member 26 and retaining force required by the particular coupling application.

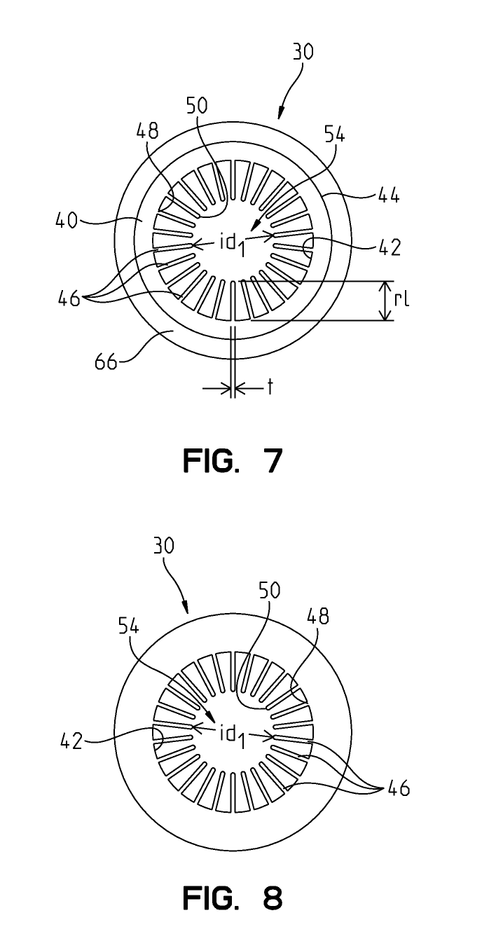

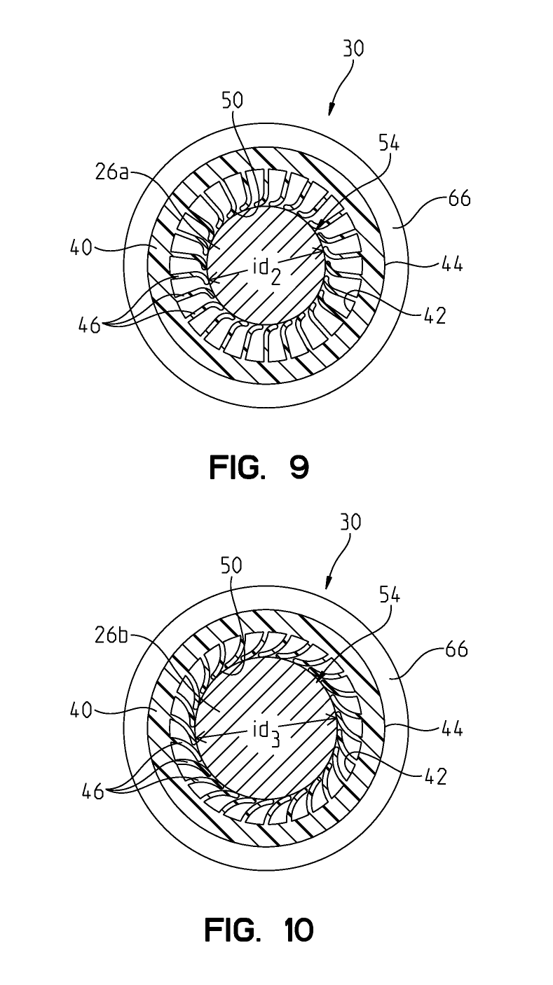

Each of the retaining fins 46 is flexible for bending movement or flexion in both tangential and radially outward directions in order to retain elongated coupled members of varying lateral dimensions and cross-sectional shapes, illustratively detonators 26 of various sizes and shapes, slidably received within the receiving bore 54. More particularly, the inner ends 50 are movable relative to the outer ends 48 of retaining fins 46 in order to change the cross-sectional size and/or shape of the receiving bore 54. The receiving bore 54 includes a first diameter (id₁) defined by the retaining fins 46 when in a relaxed mode as shown in FIGS. 7 and 8. The receiving bore 54 includes a second diameter (id₂) defined by the retaining fins 46 when in a first expanded mode in order to couple a first elongated member, illustratively a detonator 26a having a first diameter as shown in FIG. 9. The receiving bore 54 includes a third diameter (id₃) defined by the retaining fins 46 when in a second expanded mode in order to couple with a second elongated member, illustratively a detonator 26b having a second outer diameter as shown in FIG. 10.

With further reference to FIGS. 8, 9, and 10, the second diameter (id₂) is greater than the first diameter (id₁), while the third diameter (id₃) is greater than the second diameter (id₂). In the illustrative embodiment, the first diameter (id₁) is equal to 0.206 inches, the second diameter (id₂) is equal to 0.210 inches (to accommodate detonator 26a of FIG. 9), and the third diameter (id₃) is equal to 0.300 inches (to accommodate detonator 26b of FIG. 10). In other words, the fins 46 are configured to grab and hold detonators 26 having outer diameters between at least 0.210 inches and 0.300 inches. It should be appreciated that diameters (id₁, id₂, id₃) may vary depending upon the dimensions of coupled members 26. For example, in certain illustrative embodiments, the transmission line 34 of the associated detonator 24 may be retained by the fins 46 of the coupling adapter 30. In such an embodiment, the fins 46 are configured to grab and hold transmission lines 34 having outer diameters of approximately 0.200 inches. The dimensions of the first diameter (id₁), the second diameter (id₂), and the third diameter (id₃) are adjusted accordingly.

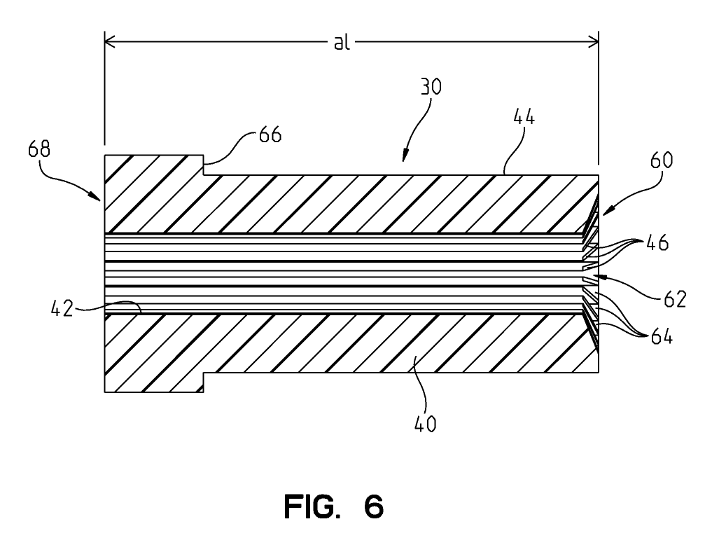

With further reference to FIG. 7, each retaining fin 46 illustratively has a thickness (t) no greater than 0.03 inches and a radial length (rl) of at least 0.09 inches. As shown in FIG. 6, each fin 46 has an axial length (al) of at least 0.25 inches in order to provide for adequate coupling through interference with the detonator casing 32. In the illustrative embodiment, the axial length (al) is 1.5 inches. Illustratively, each fin 46 is formed of a thermoplastic vulcanizate (TPV) having a hardness of between 38 durometer Shore A and 92 durometer Shore A. In certain illustrative embodiments, each fin 46 has a hardness within a range of 50 and 70 durometer Shore A. In the illustrative embodiment, the coupling adapter 30 is injection molded as a unitary component from TPV having a hardness of 60 durometer Shore A.

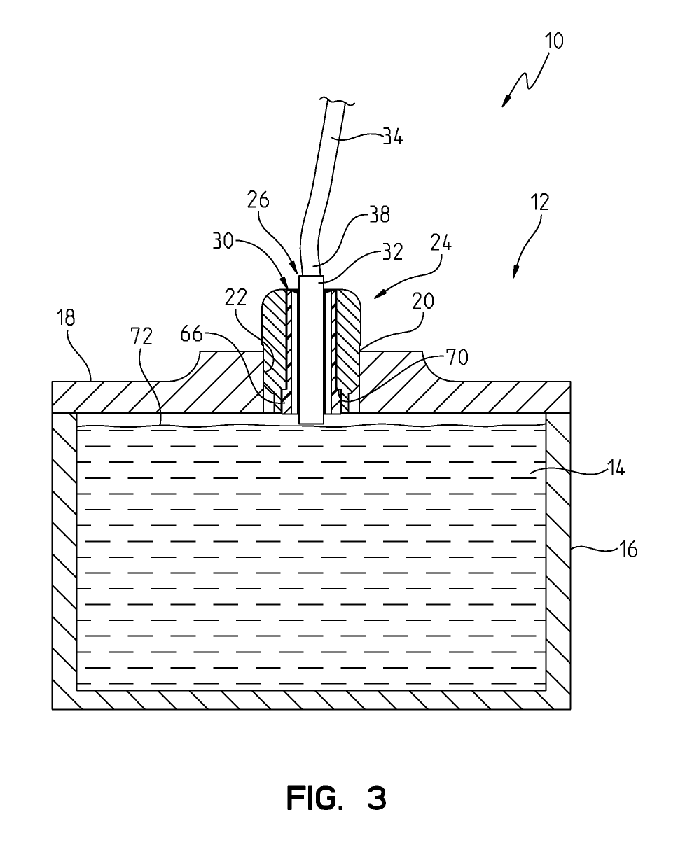

A first end 60 of the receiving bore 54 illustratively includes a frusto-conical entry 62 defined by tapered upper portions 64 of the fins 46. The frusto-conical entry 62 may be eliminated, particularly in coupling adapters 30 having short lengths. A securing lip 66 extends radially outwardly from the side wall 40 proximate the second end 68 of the receiving bore 54. The securing lip 66 illustratively facilitates coupling between the holder 24 and the cover 18 of the explosive device 10. More particularly, the securing lip 66 is received within a counterbore 70 of the holder 24 to prevent unwanted removal of coupling adapter 30 upwardly through the holder 24 of FIG. 3. With further reference to FIG. 3, the secondary explosive material 14 may restrain movement of the coupling adapter 30 downwardly through the holder 24. A slight interference fit between the outer surface 44 of the coupling adapter 30 and the holder 24 may provide further retention therebetween. Additional coupling means, such as compression ribs, adhesives, and retaining clips may be provided to further retain coupling adapter 30 within holder 24. In other illustrative embodiments, the coupling adapter 30 may be integrally molded into the housing 12 of the explosive device 10.

During assembly coupling adapter 30 is slidably inserted into the holder 24 until the securing lip 66 is received within the counterbore 70. Next, the cover 18 is secured to the canister 16 which has been filled with secondary explosive material 14. The holder 24 is then threadably received within bore 20 of cover 18 until properly positioned relative to an upper surface 72 of the secondary explosive material 14. The detonator 26 is next slidably inserted within the receiving bore 54 of the coupling adapter 30 until it abuts the upper surface 72 of the secondary explosive material 14. The inner ends 50 of retaining fins 46 bend outwardly to increase the cross-section of the receiving bore 54 wherein the casing 32 of detonator 26 is retained through an interference fit with the retaining fins 46. As such, the receiving bore 54 is self adjusting to accommodate the size and shape of detonator 26.

The coupling adapter 30 enables the housing 12 to hold detonators 26 of varying shapes and sizes. The flexible fins 46 extend inward to grab small diameter detonators or blasting caps 26a, but also give enough flexibility to accept the insertion of larger diameter detonators 26b. The flexibility of the fins 46 allows the effective internal diameter (id) of the receiving bore 54 to expand without causing an undue increase in the amount of force required to insert large diameter detonators 26b. In other words, the coupling adapter 30 provides variable diameter interference fit without requiring a “force fit.”

While the above description details use of the coupling adapter 30 in connection with detonators 26 and explosive devices 10, both military and commercial, the invention may find use with any application requiring the coupling of components of varying shapes and sizes. For example, the coupling adapter 30 may be used to provide a secure interference fit between shafts of varying diameters without causing an undo force fit or requiring specialized adapters. Any application requiring the coupling of otherwise imprecisely fitting shafts of a wide variety of shapes and sizes could benefit from the coupling adapter 30. Alternatively, the coupling adapter 30 could be adapted to rotating machinery by coupling together of inexact fitting rotating shafts.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A coupling adapter comprising:
a side wall including an inner surface;
a plurality of circumferentially spaced retaining fins supported by the side wall, each of the retaining fins extending radially inwardly from an outer end coupled to the inner surface of the side wall to an inner end;
a receiving bore defined by inner ends of the retaining fins, the receiving bore extending axially between a first end and a second end and configured to receive an elongated member; and
wherein each of the retaining fins is flexible for bending movement in tangential and radially outward directions to retain elongated members of varying lateral dimensions slidably received within the receiving bore.

2. The coupling adapter of claim 1, wherein each fin has a thickness of less than 0.03 inches and a radial length of at least 0.09 inches.

3. The coupling adapter of claim 2, wherein each fin has an axial length of at least 0.25 inches.

4. The coupling adapter of claim 1, wherein each fin has a hardness of between 38 durometer Shore A and 92 durometer Shore A.

5. The coupling adapter of claim 4, wherein each fin is formed of a thermoplastic vulcanizate.

6. The coupling adapter of claim 1, wherein the receiving bore includes a first diameter defined by the retaining fins when in a relaxed mode, the receiving bore includes a second diameter defined by the retaining fins when in a first expanded mode, and the receiving bore includes a third diameter defined by the retaining fins when in a second expanded mode, the second diameter being greater than the first diameter, and the third diameter being greater than the second diameter.

7. The coupling adapter of claim 6, wherein the first diameter of the receiving bore is approximately 0.2 inches, the second diameter is approximately 0.21 inches, and the third diameter is approximately 0.3 inches.

8. The coupling adapter of claim 1, wherein the first end of the receiving bore includes a frusto-conical portion defined by tapered upper walls of the fins.

9. The coupling adapter of claim 8, further comprising a securing lip extending radially outwardly from the side wall proximate the second end of the receiving bore.

10. The coupling adapter of claim 1, further comprising a holder operably coupled to the side wall, wherein the receiving bore defines a detonator well configured to receive a detonator configured to pass through the receiving bore and contact an explosive charge.

11. A coupling adapter comprising:
a side wall;
a plurality of circumferentially spaced retaining fins supported by the side wall, each of the retaining fins extending radially inwardly from an outer end coupled to the inner surface of the side wall to an inner end, each of the retaining fins being flexible such that the inner end is supported to move relative to the outer end;
a receiving bore defined by the retaining fins and configured to receive an elongated member; and
wherein the receiving bore includes a first diameter defined by the retaining fins when in a relaxed mode, the receiving bore includes a second diameter defined by the retaining fins when in a first expanded mode, and the receiving bore includes a third diameter defined by the retaining fins when in a second expanded mode, the second diameter being greater than the first diameter, and the third diameter being greater than the second diameter.

12. The coupling adapter of claim 11, wherein each of the retaining fins is flexible for bending movement in tangential and radially outward directions to retain elongated members of varying lateral dimensions slidably received within the receiving bore.

13. The coupling adapter of claim 11, wherein each fin has a thickness of less than 0.03 inches and a radial length of at least 0.09 inches.

14. The coupling adapter of claim 13, wherein each fin has an axial length of at least 0.25 inches.

15. The coupling adapter of claim 11, wherein each fin has a hardness of between 38 durometer Shore A and 92 durometer Shore A.

16. The coupling adapter of claim 15, wherein each fin is formed of a thermoplastic vulcanizate.

17. The coupling adapter of claim 11, wherein the first diameter of the receiving bore is approximately 0.2 inches, the second diameter is approximately 0.21 inches, and the third diameter is approximately 0.3 inches.

18. The coupling adapter of claim 11, wherein the first end of the receiving bore includes a frusto-conical portion defined by tapered upper walls of the fins.

19. The coupling adapter of claim 18, further comprising a securing lip extending radially outwardly from the side wall proximate the second end of the receiving bore.

20. The coupling adapter of claim 11, further comprising a holder operably coupled to the side wall, wherein the receiving bore defines a detonator well configured to receive a detonator configured to pass through the receiving bore and contact an explosive charge.

21. A detonator assembly for an explosive charge, the detonator assembly comprising:
a housing configured to receive an explosive charge;
a holder coupled to the housing;
a coupling adapter coupled to the holder and including a side wall, a plurality of retaining fins extending inwardly from the side wall, and a receiving bore defined by the retaining fins and having a variable cross-section defined by the retaining fins; and
a detonator received within the receiving bore, the detonator bending the inner edges of the fins outwardly to adjust the cross-section of the receiving bore and provide an interference fit between the detonator and the retaining fins.

22. The detonator assembly of claim 21, wherein each of the retaining fins is flexible for bending movement in tangential and radially outward directions to retain elongated members of varying lateral dimensions slidably received within the receiving bore.

23. The detonator assembly of claim 21, wherein the receiving bore includes a first diameter defined by the retaining fins when in a relaxed mode, the receiving bore includes a second diameter defined by the retaining fins when in a first expanded mode, and the receiving bore includes a third diameter defined by the retaining fins when in a second expanded mode, the second diameter being greater than the first diameter, and the third diameter being greater than the second diameter.

24. The detonator assembly of claim 21, wherein each fin has a hardness of between 38 durometer Shore A and 92 durometer Shore A.

25. The detonator assembly of claim 24, wherein each fin is formed of a thermoplastic vulcanizate.

26. The detonator assembly of claim 21, wherein the first diameter of the receiving bore is approximately 0.2 inches, the second diameter is approximately 0.21 inches, and the third diameter is approximately 0.3 inches.

27. The detonator assembly of claim 21, wherein the first end of the receiving bore includes a frusto-conical portion defined by tapered upper walls of the fins.

28. The detonator assembly of claim 27, further comprising a securing lip extending radially outwardly from the side wall proximate the second end of the receiving bore.

29. A method of coupling comprising the steps of:
providing a coupling adapter including a sidewall and a plurality of inwardly extending retaining fins, the retaining fins defining a receiving bore;
slidably inserting an elongated member within the receiving bore of the coupling adapter;
bending the retaining fins outwardly to increase the cross-section of the retaining bore; and
retaining the elongated member through an interference fit with the retaining fins.

30. The method of claim 29, further comprising the steps of:
providing a housing;
placing an explosive charge within the housing;
coupling a holder to the housing, the holder securing the coupling adapter to the housing; and
wherein the elongated member comprises a detonator.

31. The method of claim 30, wherein the step of slidably inserting the elongated member includes contacting the explosive charge with the detonator.

32. The method of claim 29, wherein the receiving bore includes a first diameter defined by the retaining fins when in a relaxed mode, the receiving bore includes a second diameter defined by the retaining fins when in a first expanded mode, and the receiving bore includes a third diameter defined by the retaining fins when in a second expanded mode, the second diameter being greater than the first diameter, and the third diameter being greater than the second diameter.

33. The method of claim 29, wherein each fin has a hardness of between 38 durometer Shore A and 92 durometer Shore A.

34. The method of claim 29, wherein each fin is formed of a thermoplastic vulcanizate.
